(19) United States
(12) Patent Application Publication
(10) Pub. No.: US 2012/0075115 A1
(43) Pub. Date: Mar. 29, 2012

(54) System and Method for Measuring Polar Substances

(75) Inventors: Ming-Town Lee, Taoyuan County (TW); Jen-Chi Liao, Taipei County (TW); Tung-Jung Hsu, Taoyuan County (TW)

(73) Assignee: Chung-Shan Institute of Science and Technology, Armaments, Bureau, Ministry of National Defense, Taoyuan County (TW)

(21) Appl. No.: 12/960,473

(22) Filed: Dec. 4, 2010

(30) Foreign Application Priority Data
Sep. 27, 2010 (TW) 099132715

(51) Int. Cl. G08C 19/16

(52) U.S. Cl. 340/870.01

(57) ABSTRACT

A system for measuring polar substances includes a measurement module, a transfer module, a display module and a store module. The measurement module includes a measurement unit and a transmitter. The measurement unit measures the polar substances and produces a data-related signal. The transmitter transmits the data-related signal. The transfer module includes a receiver and a transmitter. The receiver receives the data-related signal. The transmitter of the transfer module receives the data-related signal from the receiver and transmits the data-related signal. The display module receives the data-related signal from the transmitter of the transfer module and shows the data-related signal. The store module receives the data-related signal from the transmitter of the transfer module and stores the data-related signal.

### BACKGROUND OF INVENTION

1. Field of Invention

The present invention relates to motoring the quality of oil and, more particularly, a system and method for measuring polar substances in oil.

2. Related Prior Art

Many people enjoy fried (or “deep-fried”) or sautéed (or “stir-fried”) food. These people assimilate a lot of fat. Assimilation of excessive fat, trans fatty acid or saturated fat acid causes cardiovascular diseases, cancers and many other fat-related diseases. Like any other types of food, fat gets deteriorated because of oxidization after it is exposed to air, heat, light and metals for too long. For example, fat reacts with water and other substances of food at high temperature and produces unexpected substances so that it is deteriorated and smells bad. As a common practice in the food industry, used fat is not replaced with new fat every day. Used fat is seldom replaced with new fat in restaurants and chain stores. Heated fat exhibits various dangers such as degradation of vitamins A, D, E and K, oxidization of the fat, production and accumulation of hazardous substances, production of irritants in the stomach, suppression of digestive enzyme, production of inductors for free radicals, and increased risks of cardiovascular diseases and cancers.

Currently, reagent paper is used to test the quality of fat. The total amount of polar substances (acid value, fat, trans fatty acid and saturated fatty acid) in the fat is determined by the color of the reagent paper that changes after the test. The acid value must not exceed a certain limit that depends from nation to nation. The color of the test paper shows whether the total amount of the polar substances exceed the certain limit. However, the color of the test paper does not show the total amount of the polar substances.

The present invention is therefore intended to obviate or at least alleviate the problems encountered in prior art.

### SUMMARY OF INVENTION

It is the primary objective of the present invention to provide a system and method for measuring polar substances in oil.

To achieve the foregoing objective, the system includes a measurement module, a transfer module, a display module and a store module. The measurement module includes a measurement unit and a transmitter. The measurement unit measures the polar substances and produces a data-related signal. The transmitter transmits the data-related signal. The transfer module includes a receiver and a transmitter. The receiver receives the data-related signal. The transmitter of the transfer module receives the data-related signal from the receiver and transmits the data-related signal. The display module receives the data-related signal from the transmitter of the transfer module and shows the data-related signal. The store module receives the data-related signal from the transmitter of the transfer module and stores the data-related signal.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a block diagram of a system for measuring polar substances in oil according to the first embodiment of the present invention; and

FIG. 2 is a flow chart of a method for measuring polar substances in oil according to the second embodiment of the present invention.

### DETAILED DESCRIPTION OF EMBODIMENTS

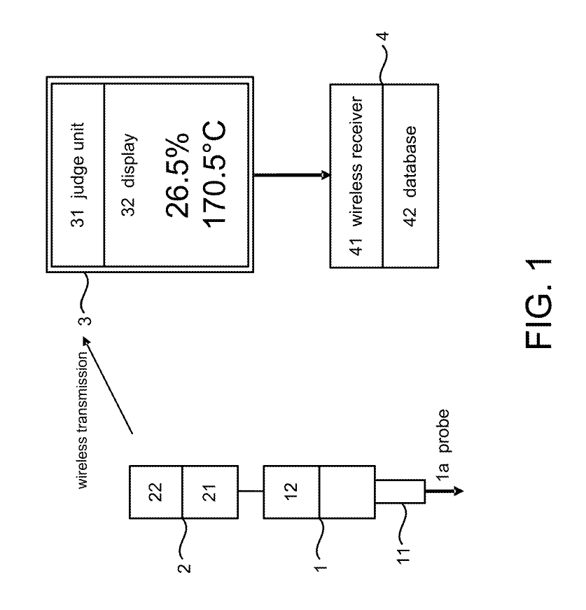

Referring to FIG. 1, referring to FIG. 1, there is shown a system for measuring polar substances in oil according to a first embodiment of the present invention. The system includes a measurement module 1, a transfer module 2, a display module 3 and a store module 4. The measurement module 1 includes a measurement unit 11 and a transmitter 12. The measurement unit 11 is preferably a probe 1a. The probe 1a is used to measure the temperature of fat and polar substances in the fat manually or automatically. After the measurement, the probe 1a produces a data-related signal and sends it to the transfer module 2 through the transmitter 12.

The transfer module 2 includes a receiver 21 and a wireless transmitter 22. The receiver 21 receives the data-related signal from the measurement module 1. The wireless transmitter 22 receives the data-related signal from the receiver 21 and transmits it to the display module 3 and the store module 4 in a wireless manner.

The display module 3 includes a judge unit 31 and a display 32. The judge unit 31 receives the data-related signal from the wireless transmitter 22, judges the data-related signal, and produces a judge-related signal as a result of the judge. The display 32 receives the data-related and judge-related signals from the judge unit 31 and shows the data-related signal according to the judge-related signal.

The store module 4 includes a wireless receiver 41 and a database 42. The wireless receiver 41 receives the data-related signal from the wireless transmitter 22 in a wireless manner. The database 42 receives the data-related signal from the wireless receiver 41 and stores it.

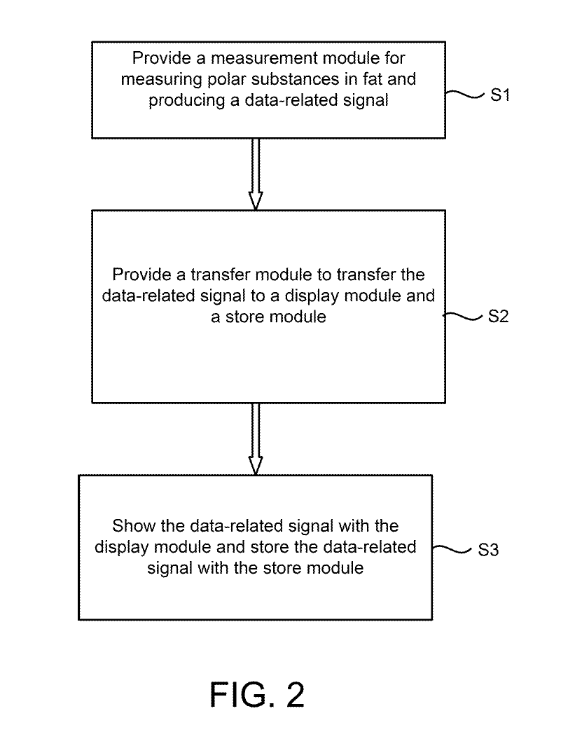

Referring to FIG. 2, there is shown a flow chart of a method for measuring polar substances in oil according to a second embodiment of the present invention. At S1, there is provided a measurement module for measuring polar substances in fat and producing a data-related signal. The measurement module includes a measurement unit and a transmitter. The measurement unit measures the polar substances and produces the data-related signal.

At S2, there is provided a transfer module to receive the data-related signal from the transmitter and transmit the data-related signal to a display module and a store module.

AT S3, the display module shows the data-related signal while the store module stores the data-related signal. The display module includes a judge unit and a display. The judge unit receives the data-related signal from the transfer module, judges the data-related signal, and produces a judge-related signal as a result. The display receives the data-related and judge-related signal from the judge unit and shows the data-related signal according to the judge-related signal.

The store module includes a wireless receiver and a database. The wireless receiver receives the data-related signal from the transfer module in a wireless manner. The database receives the data-related signal from the wireless receiver and stores it.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A system for measuring polar substances, the system including:
a measurement module 1 comprising:
a measurement unit 11 for measuring the polar substances and producing a data-related signal; and
a transmitter 12 for transmitting the data-related signal;
a transfer module 2 including:
a receiver 21 for receiving the data-related signal; and
a transmitter 22 for receiving the data-related signal from the receiver 21 and transmitting the data-related signal;
a display module 3 for receiving the data-related signal from the transmitter 22 of the transfer module 2 and showing the data-related signal; and
a store module 4 for receiving the data-related signal from the transmitter 22 of the transfer module 2 and storing the data-related signal.

2. The system according to claim 1, wherein the measurement unit 11 is a probe 1a.

3. The system according to claim 2, wherein the probe 1a is operated manually or automatically.

4. The system according to claim 1, wherein the measurement 1 is used to detect the temperature of oil.

5. The system according to claim 1, wherein the measurement 1 is used to detect polar substances in oil.

6. The system according to claim 1, wherein the transfer module 2 is a wireless transfer module.

7. The system according to claim 1, wherein the display module 3 includes:
a judge unit 31 for receiving the data-related signal from the transmitter 22 of the transfer module 2, judging the data-related signal, and producing a judge-related signal; and
a display 32 for receiving the data-related and judge-related signals from the judge unit 31 and showing the data-related signal according to the judge-related signal.

8. The system according to claim 1, wherein the store module 4 includes:
a receiver 41 for receiving the data-related signal from the transmitter 22 of the transfer module 2; and
a database 42 for receiving the data-related signal from the receiver 41 of the store module 4 and storing the data-related signal.

9. A method for measuring polar substances, the method comprising the steps of:
providing a measurement module 1 for measuring polar substances in oil and providing a data-related signal;
providing a transfer module 2 for transmitting the data-related signal;
providing a display module 3 for receiving the data-related signal from the transmitter 22 of the transfer module 2 and showing the data-related signal; and
providing a store module 4 for receiving the data-related signal from the transmitter 22 of the transfer module 2 and storing the data-related signal.

10. The method according to claim 9, wherein the measurement module 1 includes:
a measurement unit 11 for measuring the polar substances and producing a data-related signal; and
a transmitter 12 for transmitting the data-related signal;

11. The method according to claim 10, wherein the measurement unit 11 is a probe 1a.

12. The method according to claim 11, wherein the probe 1a is operated manually or automatically.

13. The method according to claim 9, wherein the measurement 1 is used to detect the temperature of oil.

14. The method according to claim 9, wherein the measurement 1 is used to detect polar substances in oil.

15. The method according to claim 9, wherein the transfer module 2 is a wireless transfer module.

16. The method according to claim 9, wherein the transfer module 2 includes:
a receiver 21 for receiving the data-related signal; and
a transmitter 22 for receiving the data-related signal from the receiver 21 and transmitting the data-related signal.
